(19) United States
(12) Patent Application Publication
(10) Pub. No.: US 2012/0254754 A1
(43) Pub. Date: Oct. 4, 2012

(54) DIGITAL MULTIMEDIA ALBUM

(75) Inventors: Christopher Gentile, Pennington, NJ (US); Adam Nemitoff, (US)

(73) Assignee: IBOARD INCORPORATED, Pennington, NJ (US)

(21) Appl. No.: 13/440,358

(22) Filed: Apr. 5, 2012

Related U.S. Application Data
(62) Division of application No. 12/711,975, filed on Feb. 24, 2010.

(51) Int. Cl. G06F 3/048

(52) U.S. Cl. 715/716

(57) ABSTRACT

A virtual or digital multimedia album. The digital album may include a collection of related media to provide virtually, what a traditional band album provides, and more. The digital album may include a set of digital audio files that replicate or substantially resemble the set of tracks found on a traditional album. Additional media, such as videos, lyric text, other text, images, and user-imported content may all be included in the digital album. The content initially provided with the digital album may be exclusively oriented to a single artist or music group. In this way, the digital album can create a much greater immersion into the themed music than a mere collection of digital audio files can provide.

### CROSS-REFERENCE TO RELATED APPLICATION

This application expressly incorporates herein by reference, the entire originally filed contents of U.S. patent application Ser. No. 12/706,545, filed on Feb. 16, 2010.

### BACKGROUND

Music, and the media on which music is provided, has experienced a rapid evolution in the computer age. Digital audio files, such as MP3s, have become the norm for audio track distribution. A user may download one song from a band, several songs from across multiple albums, or may accumulate all of the songs in a released album. Selling a set of digital audio files, where the set includes the same tracks as a retail CD release, is already performed by several MP3 e-commerce sites. Often, they will price together all the MP3s that correspond to the tracks of an album release, and sometimes offer a discount for the album set as compared to the sum of each song individually. However, this is generally the extent of so-called digital albums in the prior art, i.e., a collective pricing together of individual audio files according to the songs found on a released album. Many musical artists and groups believe this is a detriment to the experience of their fans. Acknowledging the primary experience may be in the music itself, these artists believe much is lost by stripping these songs of the other aspects of a total album experience.

### SUMMARY

Example embodiments of the present invention seek to remedy the limited artistic experience of a collection of digital audio files without context provided by the artist(s). Example embodiments may include a method of creating a digital media album that includes loading a template that defines a base structure and functionality of the album. This functionality may include at least one customization function and at least one media presentation function. The method may include defining a set of digital music pointers that each point to either a null value or a digital audio file. Further, the album may be configured to present the set of digital music pointers to an end user and the set of digital music pointers may be defined by a set of songs included on an associated traditional music album. The method may include associating digital media with the album, including digital audio, digital video, and digital still images, which may be presented via the media presentation function. The album may be configured to be downloaded by the end user, subsequent to being created, and may include functions configured to receive input from the end user modifying elements of the album or associating ether digital media with the album.

The example method may also include generating a unique serial number to be associated with the album. The album may be created as a single data file from which individual digital audio files can be extracted. The album may maintain a common theme, wherein all digital media is related to the common theme. The common theme may include songs by a single artist or band, digital video performances by the single artist or band, digital photos by the single artist or band, album song lyrics, and information about the single artist or band. Further, each of the song pointers may illustrate whether there is associated digital audio with the pointer. The album may allow the end user to import media, including associating end user supplied digital audio with a pointer and adding user-created content. The album may include links to merchandise associated with the digital media and/or the relevant artist.

Another example embodiment of the present invention may include a digital storage medium that includes electronically stored data. The example storage medium may include media data configured to be played by a digital audio player, a digital video player, or a digital image presenter. The data may define or include a set of digital music pointers that each point to either a null value or a digital audio file. The music pointers may be defined or determined by a set of songs included on an associated traditional music album. The data may also include textual data associated with each active digital music pointer that presents the lyrics associated with digital audio data. The data may include structural data based on a framework and defining a base functionality of the electronically stored data. The data may include customized structural data configured to define presentation attributes of the structural data. The data may include customizable structural data configured to receive additional data from the end user, including digital media. Finally, the data may include configuration data that may define the interrelationships between different files of the media data.

Additionally, the example electronically stored data may be configured to be downloaded by an end user as a single file. After being downloaded, the single file may be “unpacked” into multiple files. The digital audio may be stored without Digital Right Management (DRM) protection, such that the digital audio may be used on any number of digital audio players (e.g., MP3 player). Other example data may be stored in encrypted form or include other DRM protection. The example data may be stored in partitions, and may include a “shrinking install,” where each partition may be removed from the example install data as it is installed. The example data may include a plurality of digital media files, where the presentation of each file has an associated function link for sending the file or a preview of the file to another user. The transmission could include e-mailing a link to a uniquely generated webpage. That webpage may include functions for forwarding the link, or forwarding a link to a modified webpage.

Another example embodiment of the present invention may include a method of providing a digital media album on a computer system that includes providing a package of digital media, including a set of song titles and a set of other digital media related to one or more of the song titles. The example method may present the set of song titles to a user. The example method may then receive input from the user indicating for which songs from the set of song titles the user would like to receive a corresponding digital audio file. Next, the example method may transmit to the user the package of digital media, including a digital audio file for each song indicated by the user. In the example method the package may be configured to be executed by an album player with digital media presentation functions configured to present the set of song titles, the set of other digital media, and each digital audio file included in the package.

The example method may also be configured such that the set of song titles is substantially defined by a set of song titles found on a traditional album. The example set of digital media may include media such as digital audio, digital video, and digital still images. The example album may have an associated cost, and the example method may present the cost to the user, wherein full access to the album may be conditioned on payment of the cost. One example method for this is to authorize full access upon the successful download of an access key. The example method may set the cost as a function of the user input indicating which songs from the set of song titles the user would like to receive a corresponding digital audio file for. The example cost function may include a base cost for the set of other digital media plus a marginal cost for each corresponding digital audio file included in the package. The individual audio files may have their respective marginal cost set individually, e.g., they may have different costs, one or several price-points, or uniform costs. The example album provided to the end user may have a fixed set of initial content (e.g., the media included with the specified digital audio files), and the user may be able to add content via import and/or supplemental purchase. For example, the user may associate a digital audio file with a song title from the set of song titles.

### BRIEF DESCRIPTION OF THE DRAWINGS

FIG. 1A to 1G illustrate example digital multimedia album interfaces, according to one example embodiment of the present invention.

FIG. 2A illustrates an example single-file download of an example digital album, according to one example embodiment of the present invention.

FIG. 2B illustrates an example single-file download “unpacked” for installation, according to one example embodiment of the present invention.

FIG. 3 illustrates an example digital album data-structure, according to one example embodiment of the present invention.

FIG. 4 illustrates an example procedure, according to one example embodiment of the present invention.

FIG. 5 illustrates an example construction routine, according to one example embodiment of the present invention.

FIG. 6 illustrates an example method for providing an album, according to one example embodiment of the present invention.

FIG. 7 illustrates another example method for providing an album, according to one example embodiment of the present invention.

### DETAILED DESCRIPTION OF EXAMPLE EMBODIMENTS

Example embodiments of the present invention may include a digital multimedia album. Example embodiments may include a user interface for the construction, customization/modification, and presentation of one or more digital albums. Further, example embodiments may include a data structure for storing the various components of a digital album, as discussed below.

The digital album may consist of a customizable multi-media experience, consistently themed around one artist, group, or other similar entity. Once installed, a digital album may provide the user an interface with several forms of related and user-added content. Initially, the digital album may include digital audio files (e.g., MP3s). The set of digital audio files may be structured to resemble or replicate the set of digital audio tracks included on an “album” (e.g., CD) at a retail location.

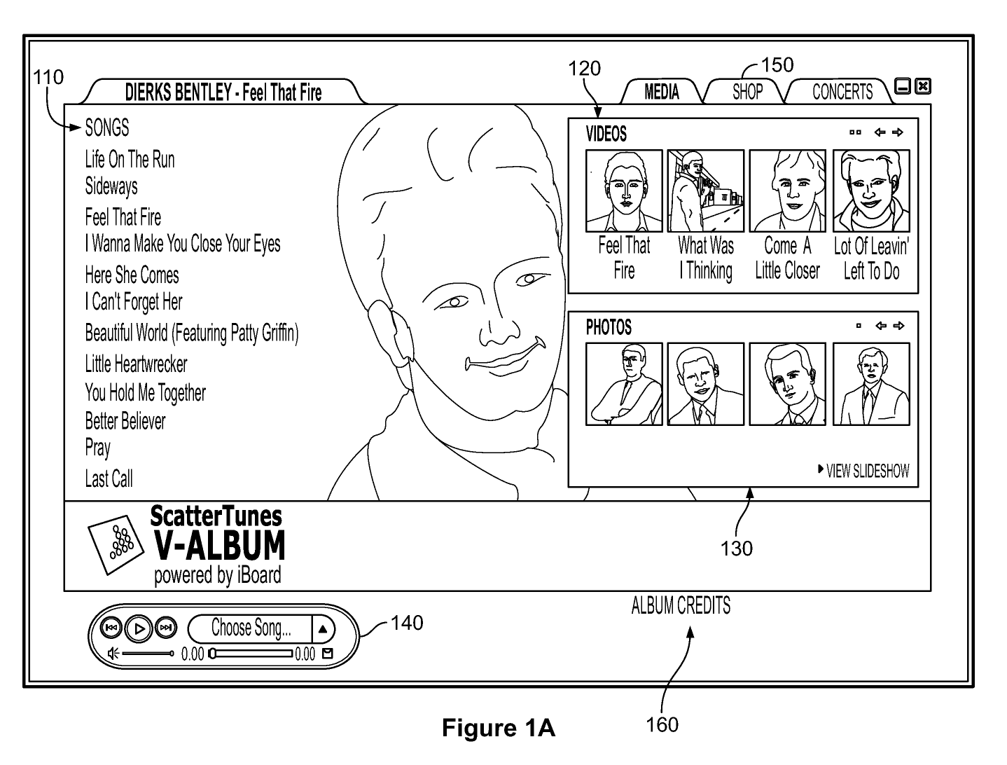

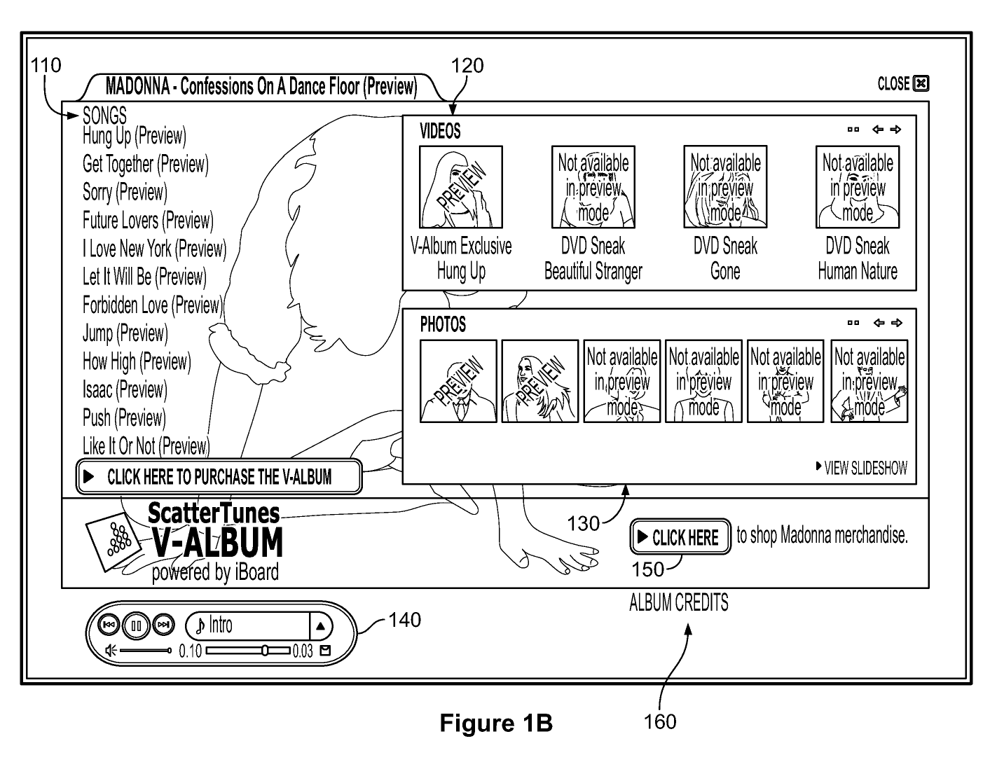

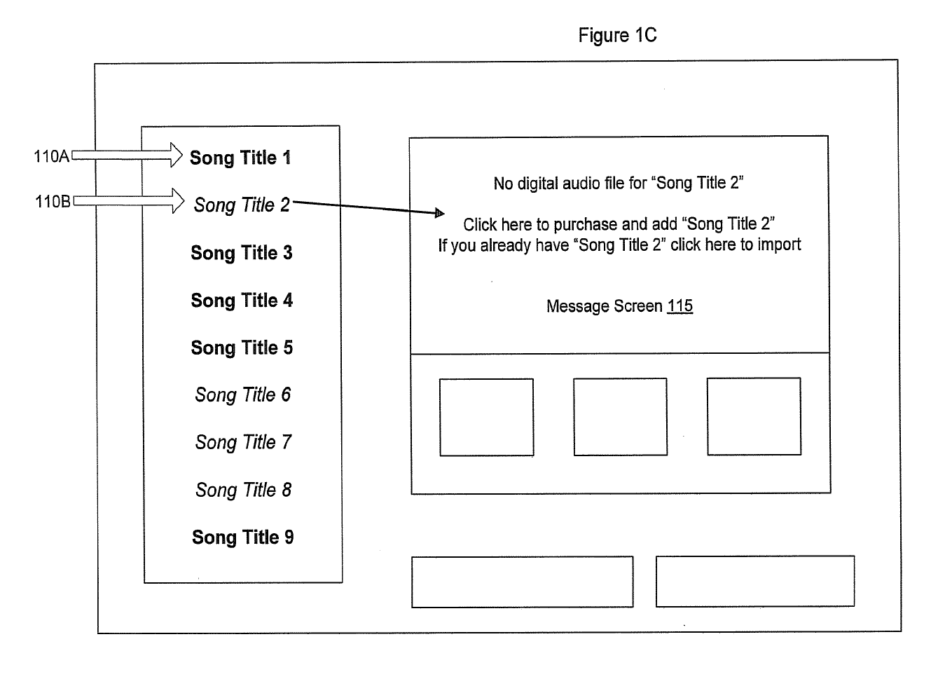

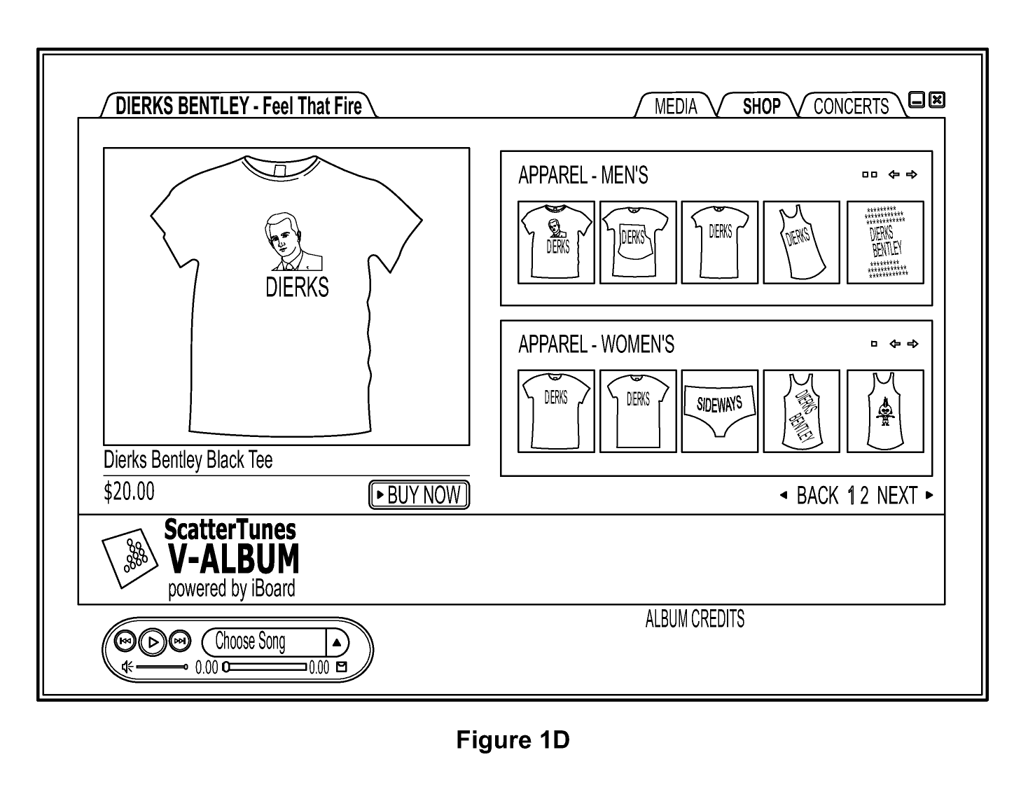

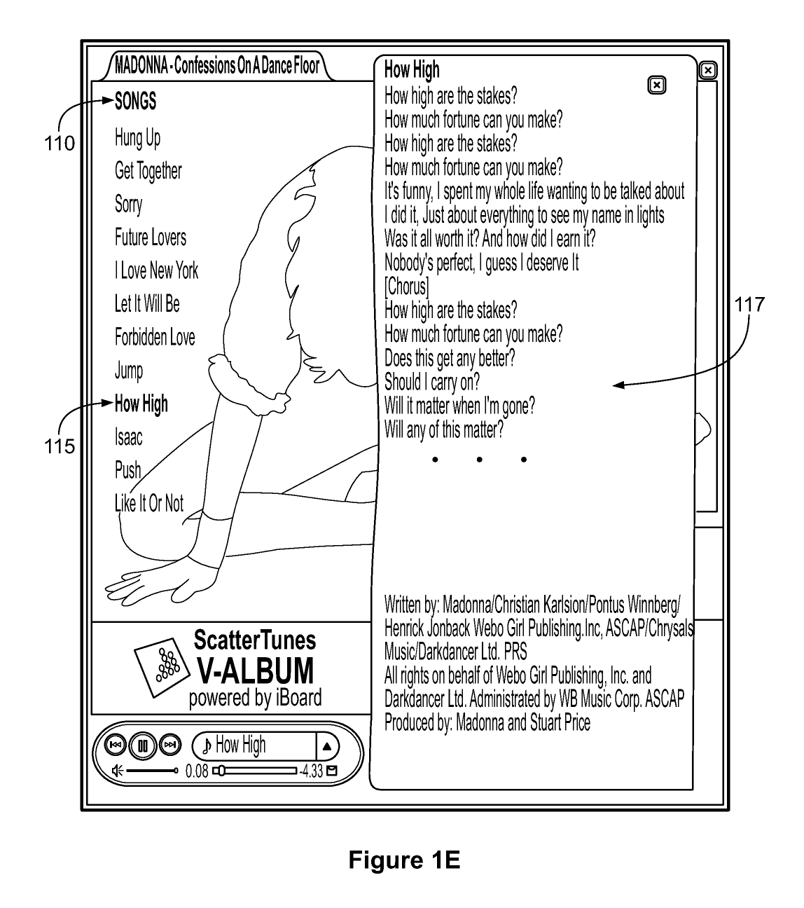

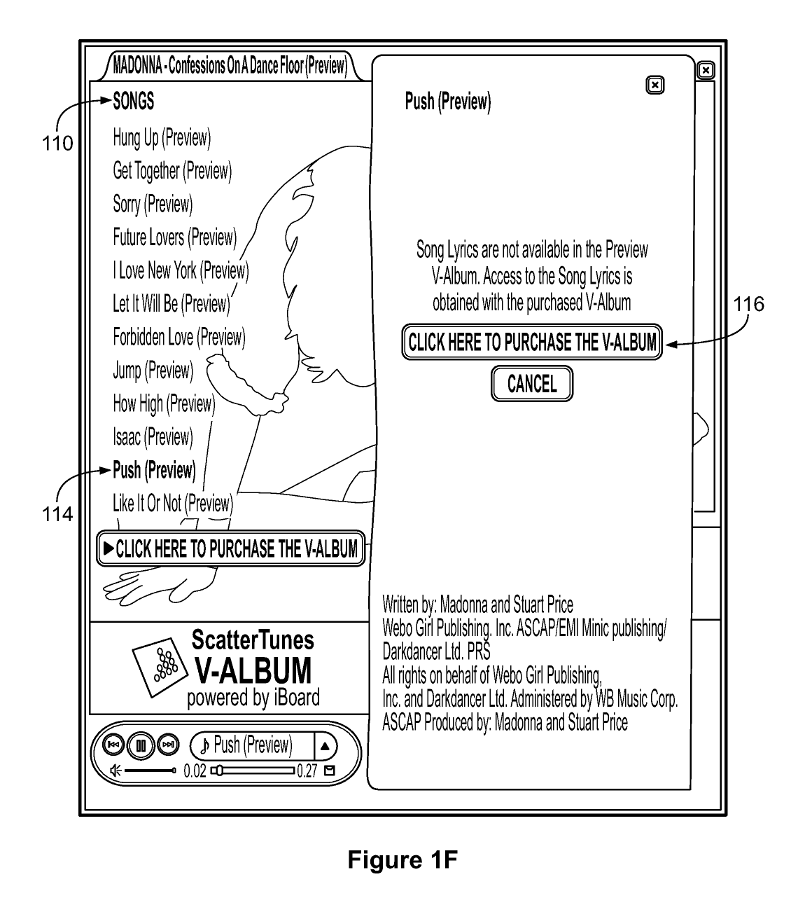

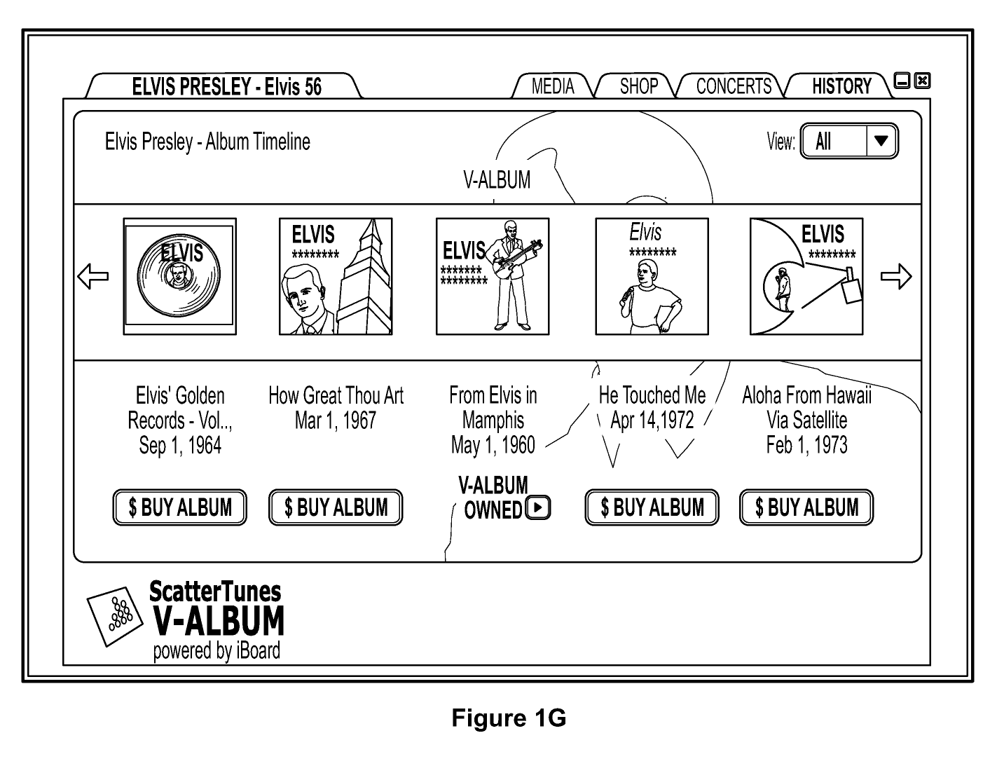

FIGS. 1A and 1B each illustrate an example embodiment of an installed digital album interface. Element 110 includes a list of song titles, and may contain pointers to digital audio files associated with those song titles. As mentioned, the list of song titles may replicate or resemble (e.g., with more or fewer bonus tracks, etc.) the set of tracks available on a retail album. Element 140 illustrates a multi-media player. In the case of songs 110, the player may play the associated digital audio file, and provide controls for playback. Element 120 illustrates a video library section. In one example embodiment, the video files may be stored with digital rights management (DRM) protection. The videos may include any number of album/artist/band-related material. For example, music videos may be associated with the digital album songs, interviews of the band members or associated persons, and/or videos of live performances by the band. Further, in addition to professional content, users may import other related content. For example, a user may have made a personal video while at a performance, a karaoke session, or other “home movie” related to the digital album content. This material may also be stored in the video library and presented in element 120. The user-added videos may be stored free of DRM protection, or may have it added at the request of the user. One example reason for this may be for certain digital albums that allow for album copies to be made, the user may want to protect the added content, before sending a copy to a friend.

The user import function may serve other purposes as well. The digital album may be available for purchase independent of the digital audio files. Thus, if a user already had all of the MP3s that comprise an album, that user could purchase only the digital album, or rather a digital album with no included digital audio files. The songs list 110 may still have all of the digital album track titles, but may indicate all or some are missing playable data. The user may then associate any digital audio file with the song title link (e.g., a previously purchased copy of the song). In this way, digital albums may be sold at varying price points, with all, some, or none of the actual digital audio files associated with the album set of titles. For example, FIG. 1C illustrates an album a user may have downloaded where only the first, third, fourth, fifth, and ninth songs are included (e.g., 110A), and the second, sixth, seventh, and eighth song titles have no associated digital audio file (e.g., 110B). The user may have purchased this album at a discount to the full album. Additionally, when the user tries to play a missing song (e.g., 110B), a message 115 may alert the user there is no associated data. The message 115 may then prompt the user to purchase the song, or import an existing file.

Additional example album elements may include element 130, which illustrates a collection of still images related to the digital album theme. This may include images of the band, artist(s), logos, graphics, cover art, band art, performance images, or any number of other still images. Similar to the video, users may also import their own home images, e.g., pictures taken while at a performance or convention. A user may have dressed as one of the artists for a party or holiday (e.g., Halloween), and want to include with the digital album images of him or her in costume. Of course, in example embodiments where user-created content is allowed to be imported into the digital album, it might not be possible to ensure the content fits with the theme of the digital album. However, example embodiments may limit the default content, or original owner updated content to theme specific content. For this reason, other example embodiments may have separate sections for user content and/or designate them in a separate manner, in order to distinguish the content that is known to fit with the digital album theme.

Element 150 illustrates a link to a merchandising section. This section may be presented in the same interface, replace the interface shown in FIGS. 1A and 1B, or launch a new interface (e.g., a web-browser). The digital album, (e.g., the interface illustrated in FIGS. 1A and 1B,) may wholly contain the related merchandise that is available for purchase, may present “stubs” of merchandise available on other sites and link to those sites, or may simply transport the user to a site known to sell related merchandise. FIG. 1D illustrates one example embodiment where the merchandise is presented within the interface. The items illustrated in FIG. 1C may bring the user to more information and checkout functions within the interface, or launch external e-commerce partner sites to complete the purchase of selected items.

Other features; such as a listing of album credits (e.g., 160) may also be available. Additionally, the digital album may contain customary navigation and menu options, such as the arrow navigation buttons in the video 120 and photo 130 areas. The digital album may include any number of other relevant features. For example, the lyrics of each song may be available to the user, and may automatically display when a song is selected and/or played. An example of this is FIG. 1E, for which the song 115 “How High” is selected, and the associated lyrics 117 are presented to the user. Also, an example digital album interface may indicate where in the textual lyrics the digital audio file is currently playing, e.g., similar to a karaoke or “sing along” system, i.e., scrolling textual lyrics. Other features may be available to the user during playback as well. For example, the user may be able to start a slide show of the included images that plays during song playback. Another example embodiment may have a slideshow synchronize with the playback audio, e.g., rotating through images according to the tempo of the currently playing digital audio file.

Digital albums may also include text-based features, beyond the lyric text associated with the song files. For example, short biographies of band members or artists associated with the particular digital album may be included, and may be associated with images of the same. News articles, press releases, and band-member-authored “statements,” e.g., open-letters to fans, etc., may also be included as text media within the digital album. Additionally, real-time text may be included. For example, a solo artist or band member may have a blog, micro-blog (e.g., “Twitter™”), or other frequently updated information feed, which may be included in the digital album, via automatic updates. The digital album may include utilities and functions to present web-cam or other web-served video/audio interviews with band members, through streaming media protocols.

Digital albums may also come in “preview” form, e.g., a limited version designed to illustrate the product and encourage purchase of the actual digital album. A preview album may include any number of limiting features. For example, songs and video may be limited to the first several (e.g., 30) seconds of playback, images may be of reduced resolution, user data import may be limited to some number (e.g., 2) of items per section, and lyrics may be limited to a few lines or totally blocked (e.g., as illustrated in FIG. 1F). Certain aspects of the preview album may be fully functioning, e.g., the merchandising section. The preview album may include a function to purchase the full digital album. The preview album may include a source identifier, which may be used to issue commissions for associated preview albums that are converted via purchase into full digital albums.

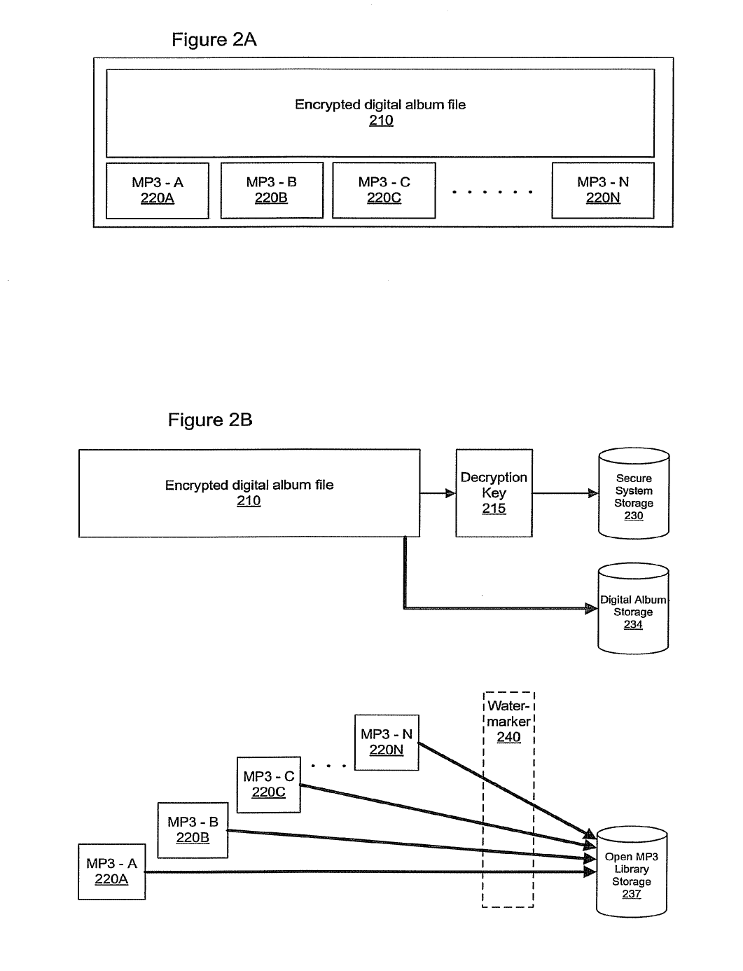

Digital albums may be delivered via a network server. Digital albums may be sold at retail locations, but this type of sale may be for a product code used to download the digital album without further purchase. Alternatively, the actual install data may be provided at the retail location. However, example embodiments may require authentication with a license server, and in this case, regardless of the origin of the install data, a network connection may be required. The digital album, as discussed above, may be a collection of different components (e.g., audio files, video files, image file, etc.). However, to minimize the load on the distribution server(s), and thus minimize the cost of product distribution, the digital album may download as a single file. For example, FIG. 2A illustrates a single file download, where an encrypted digital album file 210 is “wrapped up” with individual unencrypted MP3 files A to N. In alternative embodiments, the digital album may be distributed in more than one data packages, or from more than one distribution source.

Digital album files, e.g., FIG. 2A, may run on a digital album player, which may provide the common logic and utilities (e.g., multi-media player(s)) for one or more digital albums. Alternatively, each digital album may contain its own logic, using frameworks already on the installing system (e.g., Java plug-ins, media APIs, etc.). FIG. 2B illustrates an example deconstructing of the single digital album download file. The single digital album download file may consist of two main parts. First, a set of unencrypted digital audio files, e.g., MP3A to MP3N. Second, an encrypted file, set of files, or other data structure, which may contain all of the other digital album content, e.g., videos, images, lyrics, text, etc. This file may be referred to as the “V-Wrap” and include all of the digital content and data for the V-Album, other than the MP3 files. The V-Wrap may however, include song previews for any song associated with the V-Album, but for which there is no associated digital audio file of the complete song. In alternative embodiments, the digital audio files may be encrypted as well, or contain any number of DRM protection. However, common industry practice has evolved into allowing MP3s to be unencrypted and free of DRM protections. Likewise, the digital album data 210 (e.g., V-Wrap) may be unencrypted, or partially unencrypted.

In the example embodiment illustrated in FIG. 2B, the digital album is encrypted and contains a decryption key 215. Decryption key 215 may be removed from the digital album install data, and stored in a secure directory of the installation device. This secure directory may be provided by the device operating system, or generated by the digital album program. However, most device operating systems provide one or more secure directories for storing such files as a decryption key. The remaining data from the digital album data 210 may be installed in one or more regular directories of the main storage memory. These one or more digital album storage areas 234, may be separate or part of the digital audio library storage memory 237. In the example embodiment illustrated in FIG. 2B, the MP3s are stored in a separate memory location, to provide easy access to the user for other applications (e.g., inclusion in an MP3 player not capable of having the digital album portions installed).

In addition to “unpacking” the digital audio files 220A to 220N, and storing them in memory, whether temporary or persistent memory, the digital album application may perform certain post-download processing on the digital audio files, or any number of other data pieces from the digital album file 210. Here, the digital album program (e.g., the digital album application responsible for presenting digital albums based on the download/install content) may post-process the MP3s by adding a watermark with “water-marker” 240. This watermark could include any number of things, and may include identification (ID) unique to the digital album player installed on this device, the purchase location, IP address, date, and/or time. This way, the MP3, or other digital audio file, may remain free of DRM protection, and thus remain usably flexible, but still have a source identifier associated with the originally distributed copy.

In one example embodiment, the install process illustrated in FIGS. 2A and 2B also includes a feature of a “shrinking” install. During most install processes, an install file is executed to fully install a target program or data, and only upon completion is the entire install file then removed or marked for eventual overwrite. Here, however, because the single install file may contain very large media files, the total file (e.g., FIG. 2A) may be quite large. For example, a single four-minute music video in true high definition (HD) and native (e.g., minimal) compression, may consume over three gigabytes of disk space. Since digital albums may contain many songs and other videos, a complete set of content may include disk sizes around a hundred gigabytes. Of course this is only one example embodiment, and stronger compression, lower definition, or other space saving measures may be used. Regardless, a particular install may be quite large for some systems and users. The shrinking install allows for the amount of space needed, above the sum total size of the install file; to be no larger than the largest piece. In this way, the installer may unpack a video file, install that file in the system, and then delete that portion of the install file, thus “shrinking” the install file as pieces are no longer needed.

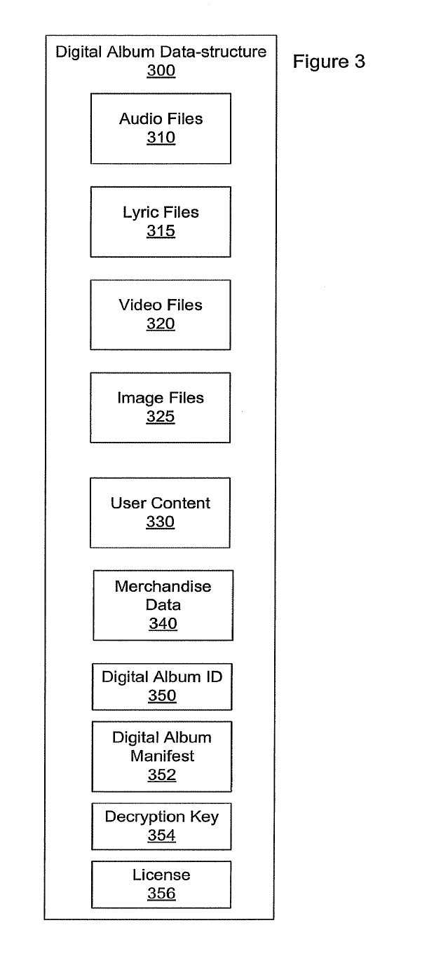

FIG. 3 illustrates an example embodiment of a digital album data structure, including components previously discussed. The example data structure may include audio files 310, (e.g., MP3s), lyric files 315, video files 320, image files 325, user content 330, and merchandise data 340. Additionally, each digital album may include a unique digital album ID 350. This ID may be used to uniquely identify every instance of a paid-for download, but may not necessarily be unique for every copy. For example, a digital album may be configured to be freely copied by the original purchaser. Thus, each instance or copy of this originally purchased digital album may share the digital album ID 350. Additionally, each digital album may include a manifest file 352. This file may be, e.g., a configuration file, instructing the digital album program how each of the many original and added digital album content components interrelate to each other, and how they should be presented.

Each digital album may include a decryption key 354, because each digital album components, other than the digital audio files, may be stored in encrypted form. In another example embodiment, the decryption key may be obtained from a central license server in response to a license request. This way, the decryption key may only be associated with active digital albums and not with unlicensed albums, e.g., those with no remaining licenses. Further, the digital album program may load the decryption key 354 into memory, and perform “just-in-time decryption.” This may enable the digital album to never write an unencrypted version of a media file to the hard-drive, and preserve the protection integrity of the components. Each digital album may have a license 356. This may include any number of things related to the legal status of a particular digital album, and may also include an indication of how many additional times the digital album may be installed. Some digital albums may have unlimited installs, some may have unlimited installs on a particular machine or location, and some may have a fixed number of installs. This feature may be customizable by the original content owner, according to their distribution needs. The client license may be associated with a master license stored at a central license server. The client license may specify certain limits and/or abilities, with the full license data stored in the master license.

In an example embodiment, content themes are not limited to newly released albums. For example, a V-Album store may present legacy albums of older (e.g., classic) album sets. For example, an artist with some number of previously issued albums, starting many years ago and representing a career of works, may have one or more of those previously released albums converted to a V-Album, for sale on the system. FIG. 1G illustrates one such example. Here, several Elvis albums are presented in chronological order. Some may indicate a V-Album for sale, and where an album has no associated V-Album, the system may provide alternative purchasing options (e.g., re-mastered CD offering, discounted MP3 set, etc.). In addition to including materials that were originally associated with the historic albums (e.g., the songs (MP3), lyrics, art, etc.), other V-Album content may be associated with the various albums. For example, several videos of the artist may be collected and associated with the V-Album closest in time with the date of the video. So each video created between the original release dates of two particular albums, may be associated with the V-Album based on the earlier of the two. In this way, a history tab, presenting the life-work of an artist may show an artistic evolution over the several years of that artist's career, by associating content with V-Albums in a specific order. Additionally, some content may be associated with every V-Album (e.g., currently available merchandise).

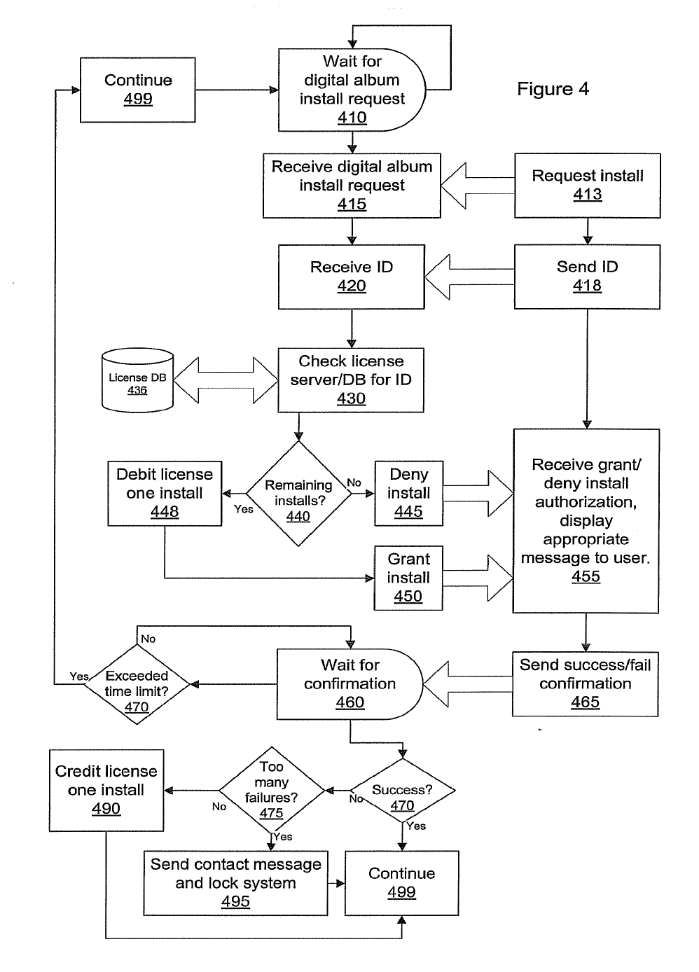

FIG. 4 illustrates one example embodiment of how the install authorization process may work. FIG. 4 illustrates both the installing device on the right side, and the authorizing system on the left side. Starting at 410, the example procedure authorizing system may wait for a new digital album install request. When a digital album is going to be installed on a device, the digital album application on that device may request an install authorization at 413, which may be received at 415. Next, at 418, the device may send the unique digital album ID (e.g., 350), which may be received at 420. Using the unique digital album ID, the authorization system may check a license server and database, to determine if allowed installs remain. This is only one example embodiment for illustrative purposes; other licensing and authorization schemes are also possible. In this example embodiment, an original content owner may have authorized some number of installs for a purchase of a particular digital album. If there are no remaining installs at 440, the authorization system may return a deny message at 445. If there are remaining installs, the authorization system may return a grant message at 450, after debiting the license one install credit at 448. These messages may be received by the installing device at 455. If a deny message is received, the digital album application may prompt the user to place a purchase for the digital album at that time. If a grant message is received, the digital album application may continue with the installation.

The authorization system may wait for a success/fail confirmation from the installation program at 460. However, if a time limit is exceeded, the authorization system may return to normal operations at 499, without returning the installation credit, as a security measure. An example embodiment may also log the event, so that a customer may call customer service to try and receive the credit back. If a success message is timely received, then the authorization system may again continue normal operation at 499. However, if a failure message is received, the authorization system may check to make sure the install has not repeatedly failed in some timeframe at 475. If it has not, the license may have one authorized install credited back at 490, and then continue at 499. If there have been too many failed attempts in some time frame, the authorization system may send, at 495, an exception that the digital album program may present to the user with an instruction to call customer service to resolve the issue. Additionally, at 495, the system may lock that digital album ID or license from future Install attempts until unlocked by a customer service representative. Subsequently, again, the authorization system may return to normal operation at 499. The example procedure illustrated in FIG. 4, is only one example embodiment, and illustrated as a concurrent and linear execution. It may be noted however, that while the steps subsequent to 410 are executing to confirm an authorized install, the example procedure may continually execute 410 for other installation requests.

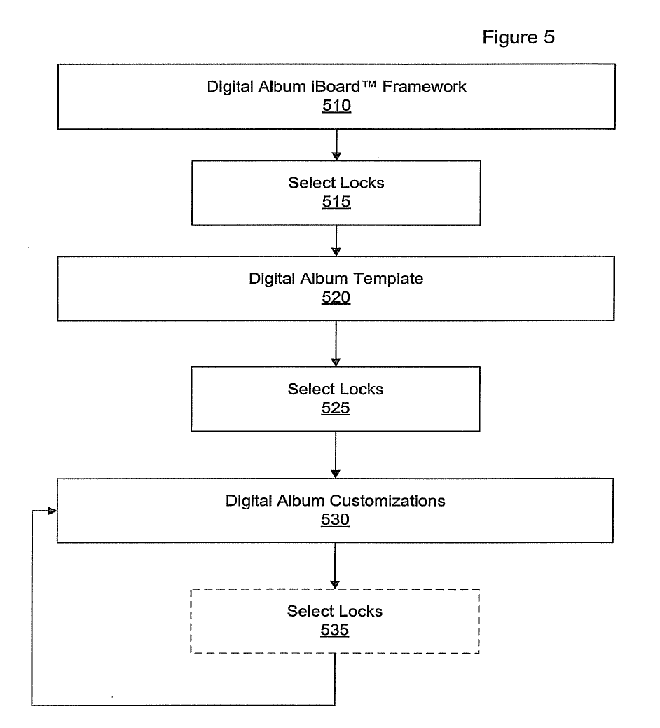

The actual structure of a digital album may be based on a progression of varying foundations and/or templates. As illustrated in FIG. 5, the digital album may begin by being built on a framework, such as an iBoard™ framework. This iBoard™ framework 510 may be a pre-established application creation framework, used to construct any number of wholly or partially independent applications. In the process of building a base digital album template 520, certain framework features and options may be left customizable or locked down at 515 by the designer of a particular version of the application. Having created a particular digital album template 520, a digital album designer may build a particular digital album using that template. At this stage, the designer may be making a retail design based on the template, for a specific artist or band. At 525, the designer may also have an opportunity to select what template features will be locked down and permanent, and which features will be customizable by the user. Once the digital album is set by 525, the retail customer may receive it via purchase, and may be able to customize the digital album according to what was left customizable at 525. Optionally, the user may also be able to lock down certain customizations, especially if the user is allowed to transmit customizable copies to other people. For example, the user may lock a personal video they added to the digital album, if they do not want that video to be extracted or modified, etc.

User customizations at 530 may include a number of modifications. For example, as was previously discussed, the user may add various pieces of content, such as videos, images, etc. Also, a user may be able to adjust the layout of the digital album, and arrange where certain features are located within the interface. The user may be able to select user settings, from playback volume to video compression style. The user may be able to add services, such as a blog-feed module, and may be able to remove services, such as the video module (e.g., 120).

Users may be provided one or more base templates and a V-Album creation application. The V-Album creation application may be sold, or alternatively may be free or free to try. One embodiment may include a free V-Album creation application that may watermark any created vAblum. A watermark may generally be any tool that allows for use of the application while obstructing the final product of the free application version. For example, included art and videos may have a semi-opaque word printed across the visuals, while audio may include a half-volume message once per time period (e.g., “this audio track belongs to a demo V-Album creation, please register your creation software at . . . ”). This way, rising artists and amateur performers may have a tool for showcasing their collection of works in a context relevant format. Once a user chooses to purchase the distribution package for the created V-Album, the various watermarks and/or DRM protections may be removed from final products created by the user of that application. A user may also be able to upload creations to a distribution server, which may automatically create a customizable webpage for that user-created vAblum upload.

The user may also be able to purchase distribution codes for the created V-Album. In one example embodiment, only user-created V-Albums with purchased distributions will have the watermark removed. For example, a user may be offered an initial V-Album package that include a template for created a V-Album, and a number of distribution codes. After the user uploads a finalized product, that user may send a distribution code to a friend, family member, or potential label/booking agent. The recipient may then download a copy of this user-created V-Album, which may include a portfolio of the user's work. Additional distribution codes may be purchased for some amount of money, or alternatively, the user may set the customizable web page for their vAblum to charge the downloader for the distribution code. The user may be able to set the price of a download, in order to profit from any payment beyond the administrator's commission/fee. Alternatively, the base fee may include a user commission, which the user may choose to waive or collect.

In alternative example embodiments, a user may not be charged for any of these services, but may be provided with them for free, or partially for free. A user-created V-Album may include an artist influences section, where the V-Album creator(s) may indicate which artists, albums, songs, or such similar item influenced the music presented in that V-Album. This list of influences may then present opportunities to purchase the V-Albums or MP3s of those influencing artists. In this scenario, user-created V-Albums may be free of charge in order to facilitate greater advertising of the established artist(s)' V-Albums. The system may also include a store for user-created V-Albums, which may accept any submission, or may screen for specific criteria (e.g., marketability). The user-created V-Album templates and creation software may include targeted advertising as an alternative or in addition to charging for use of the creation tool and templates. For example, a local photographer may advertise a discount rate for a professional cover-photo shoot, etc.

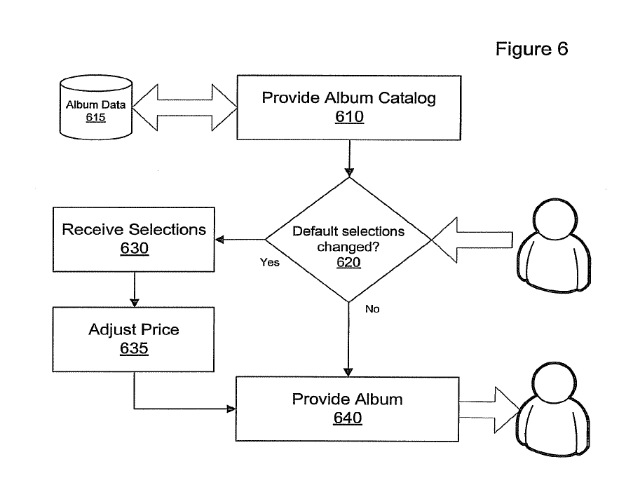

User customizations of retail V-Albums may also include finalizing a partial album. For example, FIG. 6 illustrates an example method for providing a partial album. At 610, the example method may access album data 615 and provide one or more albums available for download. As part of this example process, the user may be provided an opportunity to de-select certain content. For example, one or more of the associated digital audio files. At 630, the example method may receive these selections from the user and at 635 the example method may adjust the price accordingly. At 640, the example method may provide the album according to the user selections made. In this way, the example method may provide the user with only the content the user wants, and that content may be priced accordingly. Different albums may have different price structures, and those price structures may be fully customizable by the content owner or representative. One example structure may be to assign a cost of the album alone, e.g. $9.99. Then assign a cost for each digital audio file, which may conform to industry standards, e.g., $0.99. Accordingly, the cost of a full twelve song album may be $21.87. If a user were to deselect a song, the cost may be $0.99 less. Of course, an album may be set up to provide less of a discount than the full song cost of $0.99, and discounts may be available for quantity purchases, e.g., the whole set of files. Additionally, each song may have a different price. For example, more popular songs that are downloaded frequently may cost $1.49, and less popular songs may be discounted, e.g., $0.49, to encourage purchasing these files as well.

In addition to purchasing partial albums, as described above, partial albums may be completed with the user import functions. This way, preexisting files may be associated with song titles that have no associated digital audio file. This is only one example embodiment, and albums may be configured to only come with a complete set of digital audio files and at the full price. Content owners or other interested parties may desire to configure their albums with a locked set of digital audio files having no option for the customization of the song title/digital audio file portion of the album.

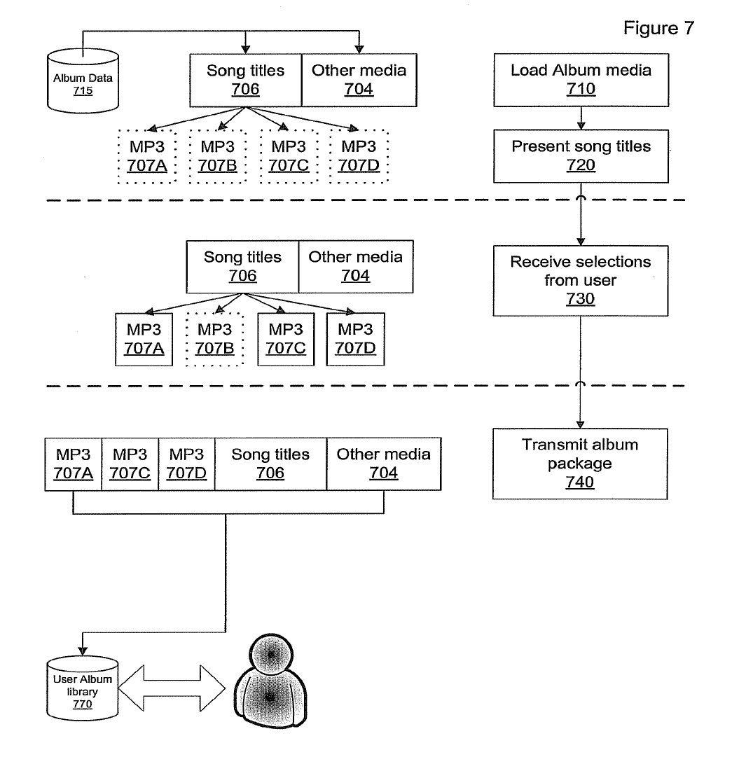

FIG. 7 illustrates another example embodiment of the present invention. An album server method may initially load album media at 710. For example, data may be loaded from a database 715, including a list of associated songs 706 (e.g., with a pointer associating a digital audio file for each song), and also including other digital media 704 that may form part of the Album. The example method may present the song titles 706 defined by a certain album at 720. Next, at 730, the example method may receive selections for a user indicating which digital audio files the user would like included in the album package, and which may be left off. Here, the digital audio files are illustrated as MP3s, and the user has selected files for 707A, C, and D. MP3 707B was not selected by the user. Once the customizable contents of the initial download are fixed, the example method may transmit the album package to the user at 740. The package may be stored and/or installed on the user system (e.g., as illustrated in FIG. 2B). Example embodiments may also require payment for the transmission, or payment may be made at a later time (e.g., at the license acquisition time illustrated in FIG. 4).

Other features are also possible in example embodiments. For example, the digital album may provide a postcard advertising/sharing system, where a digital album user may share any aspect of their digital album with another user. For example, the digital album may include a share link with every file associated with the digital album, such that when a user clicks the share link for one of the videos, a unique postcard is created for that video as it relates to that digital album, and an email is sent to a specified recipient(s). The email may contain a link to a uniquely generated website, which displays a “virtual” digital post-card, e.g., a graphic postcard consistent with the digital album theme, and presenting/streaming a 30-second preview version of the shared media. Additionally, multiple pieces of media may be shared, but the extent any media is shared may be controlled by the original content owner. For example, sharing a song or video may cause the postcard to stream the first 30-seconds, followed by an invitation to purchase a copy of the originating digital album. The receiving user may also be able to forward the postcard to other recipients, and each user may be able to add, remove, or otherwise modify the postcard before sending it off to other users. Users may be limited in only sending the V-Album content, and excluded from sending user content with this feature. Alternatively, users may be permitted to share all content, and have user created content uploaded for inclusion in the postcard.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

1-10. (canceled)

11. A method of creating a digital media album, comprising: loading a template that defines a base structure and functionality of the album, wherein the functionality includes at least one customization function and at least one media presentation function; defining a set of digital media pointers that each point to at most one digital media file, wherein the album is configured to present the set of digital media pointers to an end user and wherein the set of digital media pointers is defined by a set of titles included on an associated traditional music album; associating digital media with the album, including digital audio, digital video, and digital still images, wherein the at least one media presentation function is configured to present at least one of: digital audio, digital video, and digital still images to the end user; wherein the album is configured to be downloaded by the end user, subsequent to being created, wherein the album includes functions configured to receive input from the end user modifying elements of the album, including associating other digital media with the album.

12. The method of claim 11, further comprising: generating a unique serial number to be associated with the album.

13. The method of claim 11, wherein the album is created as a single data file from which individual digital audio files can be extracted.

14. The method of claim 13, wherein the single data file includes the digital audio files and remaining data, wherein the remaining data includes Digital Rights Management (DRM) and wherein the digital audio files do not include DRM.

15. The method of claim 11, further comprising: maintaining a common theme, wherein all digital media provided to the end user is related to the common theme.

16. The method of claim 11, wherein the digital media includes media titles by a single artist or band, wherein the digital video includes performances by the single artist or band, wherein the digital media includes information about the single artist or band.

17. The method of claim 11, wherein each pointer illustrates whether there is associated digital media with that pointer.

18. The method of claim 11, wherein the album is configured to include media imported by the end user, including associating end user supplied digital media with a pointer from the set of pointers.

19. The method of claim 11, wherein the album includes links to merchandise associated with the digital media.

20. The method of claim 11, wherein the customization functions include: importing user-created content.

21-26. (canceled)
